(19) United States
(12) Patent Application Publication
(10) Pub. No.: US 2012/0256583 A1
(43) Pub. Date: Oct. 11, 2012

(54) Low Cost Fast Charger with Internal Accumulator and Method

(76) Inventor: Stuart M. Davis, Norfolk, MA (US)

(21) Appl. No.: 13/082,643

(22) Filed: Apr. 8, 2011

(51) Int. Cl. H02J 7/04; H02J 7/00

(52) U.S. Cl. 320/103; 320/155; 320/107

(57) ABSTRACT

Disclosed is a charger device configured to charge a rechargeable battery comprising at least one rechargeable electrochemical cell includes a lead-acid battery charge accumulator device of a high discharge rate, having a discharge rate that is capable of delivering charging current to the at least one rechargeable electrochemical cell to charge the at least one rechargeable electrochemical cell within a period of about 5 to 15 minutes, a low rate 200 ma charger coupled in shunt with the lead-acid battery high discharge rate charge accumulator device and with the charger configured to re-charge the high discharge rate charge accumulator at a low charge rate, in comparison to the discharge rate of high discharge rate charge accumulator and a series resistor coupled between the accumulator and an output of the charger device.

### BACKGROUND

LiFePO₄ batteries deliver high power and can be recharged quickly at very high rates. However, in order to sustain the high power levels required for rapid charging, a charger for such batteries is typically larger and more expensive than a conventional charger for batteries that charge at lower charge rates. This attendant cost is due to the cost of larger/higher performance components needed in such battery chargers to fast charge LiFePO₄ batteries.

### SUMMARY

According to an aspect of the present invention, a method for charging a rechargeable battery that includes at least one rechargeable electrochemical cell is disclosed. The method includes charging the rechargeable battery at a high rate from a charge accumulator device that has a discharge rate that is capable of delivering charging current to the rechargeable electrochemical battery to charge the rechargeable electrochemical cell within a period of about 5 to 15 minutes; and recharging the charge accumulator using a low charge rate charger, with the charge rate to recharge the charge accumulator being low in comparison to the charging rate of the rechargeable battery.

Embodiments may include one or more of the following.

The charge accumulator is a lead-acid battery. The charge accumulator reaches an approximately 13% depth of discharge for a single charge of the rechargeable battery. The low rate charger is a 200 ma. charger. The charge accumulator is a supercapacitor.

In other embodiments, the charge accumulator is a rechargeable Ni—MH battery. Ni—Cd battery, Ni—Zn battery, Ni—Fe battery, Ag₂O—Zn battery, AgO—Zn battery, Ag₂O—Cd battery, AgO—Cd battery, Ag₂O—MH battery, AgO—MH battery or a high rate Lithium rechargeable battery such as Li—FePO₄. The charge accumulator may be physically larger and be rated to contain substantially higher energy (W-hr) than the rechargeable battery it is intended to recharge, to assure that the charge accumulator is capable of recharging the rechargeable battery at a very high rate.

According to an additional aspect of the present invention, a charger device configured to charge a rechargeable battery comprising at least one rechargeable electrochemical cell, the device includes a charge accumulator device that has a discharge rate that is capable of delivering charging current to the at least one rechargeable electrochemical cell to charge the at least one rechargeable electrochemical cell within a period of about 5 to 15 minutes; and a low charge rate charger configured to re-charge the charge accumulator at a low charge rate, in comparison to the charge rate of the electrochemical cell.

Embodiments may include one or more of the following.

The charge accumulator is a lead-acid battery. The charge accumulator reaches approximately 13% depth of discharge for a single charge of the rechargeable cell. The low rate charger is a 200 ma charger. The charger device further includes protection circuitry coupled to the high discharge rate accumulator. The protection circuitry comprises a resistor coupled in series between the accumulator and an output of the charger. The accumulator is coupled in shunt with the low rate charger and output terminals of the charger device. The accumulator is coupled in shunt with the low rate charger, and the resistor and output terminals of the charger device.

According to an additional aspect of the present invention, a charger device configured to charge a rechargeable battery comprising at least one rechargeable electrochemical cell includes a lead-acid battery or other high discharge rate charge accumulator device having a discharge rate that is capable of delivering charging current to the at least one rechargeable electrochemical cell to charge the at least one rechargeable electrochemical cell within a period of about 5 to 15 minutes, a low rate 200 ma charger coupled in shunt with the lead-acid battery high discharge rate charge accumulator device and with the charger configured to re-charge the high discharge rate charge accumulator at a low charge rate, in comparison to the discharge rate of high discharge rate charge accumulator and a series resistor coupled between the accumulator and an output of the charger device.

Other aspects of the present invention are possible.

One or more of the above aspects may include one or more of the following advantages.

The above arrangements may provide chargers at reduced costs in comparison to conventional chargers used to fast charge LiFePO₄ batteries. For example, for LiFePO₄ batteries the power (energy delivered per unit time) required charge such batteries to have charging accomplished within about 5 minutes to 15 minutes requires a charger having relatively expensive components.

In addition to charging a LiFePO₄ battery from an electrical outlet, the charger incorporates an internal accumulator that stores several charges worth of energy for a LiFePO₄ battery for use in the event of a power outage. Such a supply of reserve electrical power is stored in the charger itself (in the accumulator) which could furnish one or more recharges to such a LiFePO₄ battery for emergency use, e.g. in the case of a cell-phone or emergency radio powered by such a battery, or even when powered by another type of rechargeable battery such as conventional Li-ion, Li-Polymer, Ni—MH etc.

Other features and advantages of the invention will be apparent from the description and from the claims.

### DESCRIPTION OF THE DRAWING

FIG. 1 is a block diagram of an exemplary embodiment of a charger with an accumulator.

FIG. 2 is a block diagram of the charger with an alternative protection circuit.

### DETAILED DESCRIPTION

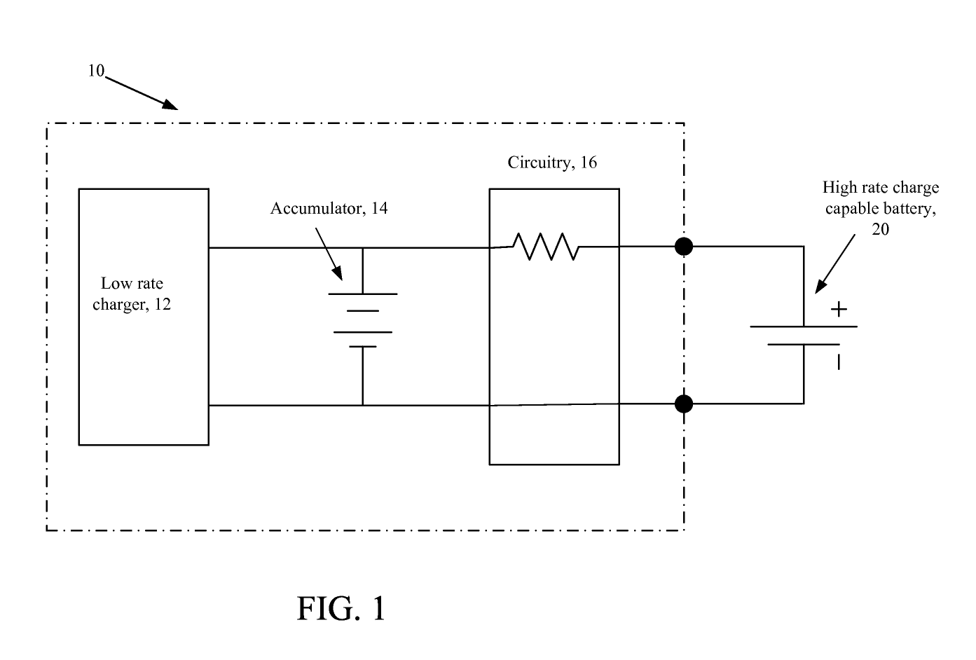

Referring to FIG. 1, a relatively low cost, high rate charger 10 for charging high-charge rate capable battery cells 20 is shown. The relatively low cost, high rate charger 10 is configured to charge rechargeable batteries that can withstand high currents and high charge rates, such as Li—FePO4 batteries to have charging accomplished within about, e.g., 5-15 minutes and includes a low cost, low charge rate charger 12 an internal rechargeable cell or battery (termed herein an “accumulator” 14) that acts as a fast charging interface, and which is coupled between the small, low rate charger 12 and the external battery 20. Also included is circuitry 16 that provides the requisite DC charging voltage at the output of the charger 10. Circuitry 16 includes optional protection circuitry as well as optional circuitry that reduce or steps up the voltage, as needed, to provide the requisite output voltage from the charger 10 to the rechargeable battery 20. One such circuit limits inrush current into the Li—FePO4 cell, by use of a high wattage resistor, low resistance generally in a range of about 0.05 ohms to about 0.5 ohms with 0.1 ohms being a typical value that is placed in series, between the Pb-acid battery and the Li—FePO4 cell.

As an illustrative example, for a Li—FePO₄ battery that can be charged within about 5 minutes at an approximate rate of 1.8 Wh/0.083 hr.=21.6W or about 6.0A a lead-acid battery is employed. Exemplary lead acid batteries can be obtained from Protection Tech (Protection Tech 2751 152^{nd} Ave. Redmond Wash. 98052) in a variety of configurations and voltages, such as 2V, 4V, 6V, 8V etc. One such Pb acid battery is model UB634, a 6V, 3.4 Ah that weighs 1.52 lbs. Another suitable model is UB445, 4V, 4.5 Ah, 1.43 lbs. These batteries are sealed, meaning that the lead acid battery as it recharges recombines suppressed gases eliminating the need to add water. Because the batteries are tightly sealed the batteries will generally neither leak nor require periodic topping off with water. Typically, two techniques are used to seal such batteries by immobilizing the electrolyte to eliminate free-flowing acid. One technique is the use of a gel cell, e.g., a gel such as a silica based gel is added to the electrolyte, causing the electrolyte to “set” in a gelatin form. The other is the use of absorbed glass mat (AGM), in which highly absorbent glass mat separators are used between each plate to retain the liquid electrolyte.

Exemplary charge rates for the accumulator of C/5 to 3C (in terms of the charge rate for the LiFePO₄ battery) or (C/40 to C/2 in terms of the accumulator) cover commonly available chargers. Whereas the discharge rate from the accumulator would be from about 5 C to about 30 C (in terms of the LiFePO₄ battery) (2.5 A to 15 A), where C is charge capacity in amp hrs.

One specific configuration for the accumulator battery is to have the manufacturer modify a 3 cell model, such as the model UB634 to eliminate one of the cells, providing a “2/3 UB634” model rated at 4V, with 3.4 Ah. In this configuration the Pb acid battery energy would be about 13.6 Wh or 7.6× that of the Li—FePO4 cell to be recharged. Therefore, the Pb acid cell need only be discharged to about 13% Depth of Discharge (DOD), favoring a high cycle life, e.g., on the order of 1,000-2,000 cycles (inference from published data for the Hawker Energy sealed Pb-acid “D” cell) to the LiFePO₄. (Hawker P.O. Box 808 9404 Ooltewah Industrial Drive Ooltewah, Tenn. 37363 USA). Similarly, from published Hawker “D” cell data, it can be expect that a discharge rate of 10 A (apx. 40 W) is sustainable for 6 minutes before voltage falls below 3.6V. Typical recharge times for the Hawker cell are about 1 hr for 100% charge. Therefore, the modified model UB634, 4V Pb-acid battery should be capable of delivering up to 4 Wh over a period of 6 minutes or twice the power required to fully recharge the prismatic Li—FePO4 battery.

The charger 10 is configured to have the accumulator reach only about 13% DOD for a single re-charge of the LiFePO₄ cell. The charger 12 is configured to allow at least about 1 hr. (or more) to recharge the Pb-acid cell. Such a charger 10 uses a very small charger, e.g. a 200 mA charger to recharge the accumulator. A 200 mA charger can fully recharge a 3.4 Ah Pb-acid battery in 17 hours. To “top off” the Pb-acid battery after a single Li—FePO4 recharge cycle, only about 400 mAh would be needed, which requires just 2 hours of charging.

Other accumulator types could be employed in place of Pb-acid such as Ni—MH, Ni—Fe etc. although on a cost basis Pb-acid is probably most economical. A 2 cell/4V Pb-acid battery is also convenient as it is a close match to the 3.8V usually used to taper charge a Li—FePO4 cell. Optionally, the charger and/or the accumulator unit can display its own “state of charge” using a low-power LCD display that is coupled to the controllers (not shown) in the charger 12. The display can be configured to display the number of recharge cycles remaining available in the accumulator 14.

Because the charger 10 provides a portable source of energy, it may be used to recharge the Li—FePO4 battery “on the go” away from any power outlet. When not charging a battery the charger 10 is coupled to a power outlet to re-charge the accumulator 14. While this scheme could have a relatively larger size and weight of the charger 10 compared to fast chargers that do not employ a Pb-acid based internal accumulator the increased volume and weight could be acceptable in view of the emergency power storage feature and potential cost savings. The main cost is in the 4V Pb-acid battery, further cost savings and size reduction might be possible by sacrificing some battery capacity, e.g. 2.0 Ah instead of 3.4 Ah. This should still provide for 2 fast recharge cycles and additional 1-2 slower recharges, in the event of a power outage.

The charger 10 is particularly useful for charging battery cells of various sizes, including battery cells used in many modern portable consumer electronic products, such as cellular telephones, MP3 players and digital cameras. The disclosed charger 10 may be applied to many different rechargeable battery types, including lithium ion batteries having high rate charge capability, such as those using lithium iron-phosphate or similar phosphate based intercalation compounds as one of the battery electrodes. The disclosed charger 10 may further be configured to charge different types of batteries, including, for example, cylindrical batteries, prismatic batteries, button-cell batteries, and so forth.

The accumulator 14 and the battery 20 are secondary cells (or batteries). While primary electrochemical cells are meant to be discharged, e.g., to exhaustion, only once, and then discarded, secondary electrochemical cells can be recharged for many times.

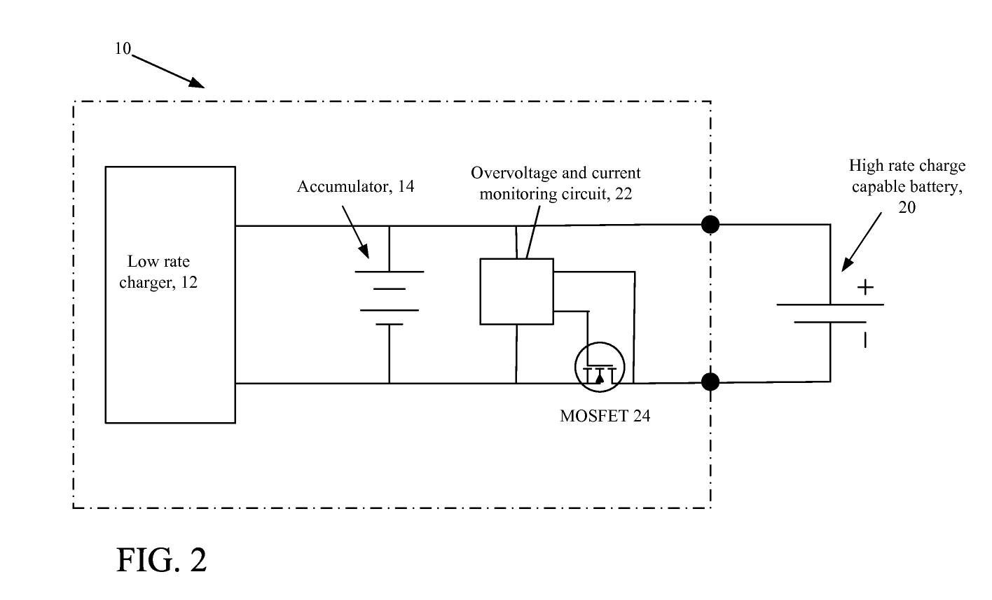

Referring to FIG. 2, an alternative arrangement for the protection circuit is shown to include a circuit 22 to monitor voltage and current conditions and an enhancement, n-type MOSFET 24 with an internal ground connection. When circuit 22 detects an overvoltage condition it causes the MOSFET to prevent charging when the external battery voltage reaches a set threshold, in a similar manner as is conventionally done with Li-Ion battery packs.

### OTHER EMBODIMENTS

A number of embodiments of the invention have been described. Nevertheless, it will be understood that various modifications may be made without departing from the spirit and scope of the invention. For example, the charge accumulator can use other types of high storage, fast discharge components, such as so called “supercapacitors”, i.e., “electric double-layer capacitors.” With a supercapacitor because the discharge voltage can vary based on remaining charge it would be desirable to place a DC-DC converter (e.g., a boost type or buck-boost type of converter at the output of the supercapacitor prior to the rechargeable cell. In other embodiments, the charge accumulator is a rechargeable Ni—MH battery. Ni—Cd battery, Ni—Zn battery, Ni—Fe battery, Ag₂O—Zn battery, AgO—Zn battery, Ag₂O—Cd battery, AgO—Cd battery, Ag₂O—MH battery, AgO—MH battery or a high rate Lithium rechargeable battery such as Li—FePO₄. The charge accumulator may be physically larger and be rated to contain substantially higher energy (W-hr) than the rechargeable battery it is intended to recharge, to assure that the charge accumulator is capable of recharging the rechargeable battery at a very high rate.

Accordingly, other embodiments are within the scope of the following claims.

What is claimed is:

1. A method for charging a rechargeable battery comprising at least one rechargeable electrochemical cell, the method comprising:
charging the rechargeable battery at a high rate from a charge accumulator device that has a discharge rate that is capable of delivering charging current to the rechargeable electrochemical battery to charge the rechargeable electrochemical cell within a period of about 5 to 15 minutes; and
recharging the charge accumulator using a low charge rate charger, with the charge rate to recharge the charge accumulator being low in comparison to the charging rate of the rechargeable battery.

2. The method of claim 1 wherein the charge accumulator is a lead-acid battery.

3. The method of claim 2 wherein the charge accumulator reaches an approximately 13% depth of discharge for a single charge of the rechargeable battery.

4. The method of claim 1 wherein low rate charger is a 200 ma. charger.

5. The method of claim 1 wherein the charge accumulator is a supercapacitor.

6. A charger device configured to charge a rechargeable battery comprising at least one rechargeable electrochemical cell, the device comprising:
a charge accumulator device that has a discharge rate that is capable of delivering charging current to the at least one rechargeable electrochemical cell to charge the at least one rechargeable electrochemical cell within a period of about 5 to 15 minutes; and
a low charge rate charger configured to re-charge the charge accumulator at a low charge rate, in comparison to the charge rate of the electrochemical cell.

7. The charger device of claim 6 wherein the charge accumulator is a lead-acid battery.

8. The charger device of claim 6 wherein the charge accumulator reaches approximately 13% depth of discharge for a single charge of the rechargeable cell.

9. The charger device of claim 6 wherein the low rate charger is a 200 ma charger.

10. The charger device of claim 6 further comprising:
protection circuitry coupled to the high discharge rate accumulator.

11. The charger device of claim 10 wherein the protection circuitry comprises:
a resistor coupled in series between the accumulator and an output of the charger.

12. The charger device of claim 6 wherein the accumulator is coupled in shunt with the low rate charger and output terminals of the charger device.

13. The charger device of claim 11 wherein the accumulator is coupled in shunt with the low rate charger, and the resistor and output terminals of the charger device.

14. A charger device configured to charge a rechargeable battery comprising at least one rechargeable electrochemical cell, the device comprising:
a lead-acid battery that has a high discharge rate to provide a charge accumulator device that has a discharge rate that is capable of delivering charging current to the at least one rechargeable electrochemical cell to charge the at least one rechargeable electrochemical cell within a period of about 5 to 15 minutes; and
a low rate 200 ma charger coupled in shunt with the lead-acid battery high discharge rate charge accumulator device and with the charger configured to re-charge the high discharge rate charge accumulator at a low charge rate, in comparison to the discharge rate of high discharge rate charge accumulator; and
a series resistor coupled between the accumulator and an output of the charger device.
